(19) United States
(12) Patent Application Publication
(10) Pub. No.: US 2013/0340906 A1
(43) Pub. Date: Dec. 26, 2013

(54) D SPEED AGRICULTURE TIRES

(71) Applicants: Bradley J. Harris, New London, OH (US); Joseph M. Lanzarotta, Uniontown, OH (US)

(72) Inventors: Bradley J. Harris, New London, OH (US); Joseph M. Lanzarotta, Uniontown, OH (US)

(21) Appl. No.: 13/533,399

(22) Filed: Jun. 26, 2012

(51) Int. Cl. B60C 11/11

(52) U.S. Cl. 152/209.12

(57) ABSTRACT

A “D speed” agricultural tire for self-propelled agricultural equipment can intermittently travel on the highway at speeds up to 40 mph. A sub-tread layer of high natural rubber content compound is placed between the tread and the polyester belts of the tire to aid in reducing internal heat generation adjacent the belts.

### FIELD OF THE INVENTION

The present invention relates to pneumatic tires, and more particularly to tires for use on self-propelled agricultural equipment.

### BACKGROUND OF THE INVENTION

Large self-propelled agricultural equipment such as tractors, combines and high clearance sprayers spends most of its time in the field, but intermittently has the need to move over the public roads from one field to another. As the design of such equipment increases in size and cost, there is an increasing desire to minimize the down time of the equipment by moving it as rapidly as possible when it is moving over the public roads from one field to another.

In the 1980's, the typical maximum transport speed for such equipment was approximately 20 mph. Today, most such equipment still does not exceed 30 mph in transport mode. At speeds up to 30 mph, the tires utilized on such agricultural equipment typically do not generate sufficient heat to affect the load carrying capability and life of the polyester belts with which such tires are typically constructed.

Current market demands, however, are now pushing the design of tires for such agricultural equipment to be capable of operating at speeds of up to 40 mph when traveling on the public roads. Per industry categories, tires designed for speeds up to 40 mph are known as “D speed” category tires.

Thus there is a continuing need for improvement in agricultural tires to accommodate these increased speeds.

### SUMMARY

In one embodiment a pneumatic agricultural tire includes a circumferential tread portion including first and second rows of tread lugs extending from first and second shoulders of the tread portion toward an equatorial plane of the tire. The lugs extend at an angle of from 0° to 65° to a rotational axis of the tire. The tread portion has a ratio of contact area to total tread area of no greater than about 40%. The tire includes a pair of bead portions and a pair of sidewall portions extending from the bead portions to the tread portion. A carcass including at least one carcass ply extends circumferentially about the tire. The carcass ply includes an axially inner portion and axially outer turn-up portions that extend around the bead portions and extend upwardly towards the tread portion and terminate at turn-up ends. A plurality of circumferentially extending belts are disposed between the carcass and the circumferential tread portion. A sub-tread compound layer is located between the circumferential tread portion and the belts. The sub-tread compound layer has a lower hysteresis than the circumferential tread portion so that the sub-tread compound layer generates less heat internally than does the circumferential tread portion. The sub-tread compound layer has a thickness of at least 0.1 inch.

In another aspect a pneumatic agricultural tire includes a tread portion including first and second rows of tread lugs extending from first and second shoulders of the tread portion toward an equatorial plane of the tire. The lugs extend at an angle of from 0° to 65° to a rotational axis of the tire. The tread portion has a ratio of contact area to total tread area of no greater than 40%. The tread portion has an outside diameter of at least about 55 inches. The tire includes a pair of opposing bead portions, and a carcass including at least one radial carcass ply. Each carcass ply has an axially inner portion and two turn-up portions. One turn-up portion extends from each end of the axially inner portion and has a terminal end. The axially inner portion extends between the opposing bead portions, and the turn-up portions are located axially outward of the bead portions. The tire includes reinforced plurality belts. The belts are disposed between the carcass and the tread portion. A sub-tread compound layer is located between the circumferential tread portion and the belts. The sub-tread compound layer is a low hysteresis sub-tread compound layer. The sub-tread compound layer is formed of a uniform thickness calendared sheet having a thickness in a range of from 0.1 to 0.3 inch.

Numerous objects features and advantages of the present invention will be readily apparent to those skilled in the art upon a reading of the following disclosure when taken in conjunction with the accompanying drawings.

### BRIEF DESCRIPTION OF THE DRAWINGS

FIG. 1 is a schematic view of an agricultural machine, in this case a self-propelled sprayer, utilizing the tires of the present invention.

FIG. 2 is a schematic cross-section view of the tire of the present invention.

FIG. 3 is an enlarged cross-sectional view of one embodiment of one half of the tire of FIG. 2 with the drawing being split along the equatorial plane of the tire.

FIG. 4 is an enlarged view of the circled area of FIG. 3, showing an alternative embodiment.

FIG. 5 is a laid out view of the lugs of the tread portion.

### DETAILED DESCRIPTION OF THE INVENTION

### Definitions

Following are definitions of selected terms employed herein. The definitions include various examples and/or forms of components that fall within the scope of a term and that may be used for implementation. The examples are not intended to be limiting. Both singular and plural forms of terms may be within the definitions.

“Aspect ratio” means the ratio of the tire's section height to its section width.

“Axial” and “axially” refer to directions which are parallel to the axis of rotation of a tire.

“Bead” or “bead core” refers to that part of a tire comprising an annular tensile member, the bead core, wrapped by ply cords and shaped, with or without other reinforcement elements to fit a designed tire rim.

“Belt” or “belt ply” refers to an annular layer or ply of parallel cords, woven or unwoven, underlying the tread, not anchored to the bead.

“Carcass” refers to the tire structure apart from the belt structure, tread, undertread, and sidewall rubber but including the beads, (carcass plies are wrapped around the beads).

“Circumferential” refers to lines or directions extending along the perimeter of the surface of the annular tread perpendicular to the axial direction.

“Copolymer” means a polymer that includes mer units derived from two reactants, typically monomers, and is inclusive of random, block, segmented, graft, gradient, etc., copolymers.

“Cord” means one of the reinforcement strands of which the plies in the tire are comprised.

“Crown” refers to substantially the outer circumference of a tire where the tread is disposed.

“Equatorial plane (EP)” refers to a plane that is perpendicular to the axis of rotation of a tire and passes through the center of the tire's tread.

“Inner liner” means the layer or layers of elastomer or other material that form the inside surface of a tubeless tire and that contain the inflating fluid within the tire.

“Nominal rim diameter” means the average diameter of the rim flange at the location where the bead portion of the tire seats.

“phr” means parts by weight of a referenced material per 100 parts by weight rubber, and is a recognized term by those having skill in the rubber compounding art.

“Polymer” means the polymerization product of one or more monomers and is inclusive of homo-, co-, ter-, tetra-polymers, etc.

“Ply” means a continuous layer of rubber coated parallel cords.

“Radial” and “radially” refer to directions that are perpendicular to the axis of rotation of a tire.

“Radial-ply” or “radial-ply tire” refers to a belted or circumferentially-restricted pneumatic tire in which the ply cords which extend from bead to bead are laid at cord angles between 65 degree and 90 degree with respect to the equatorial plane of the tire.

“Section height” (SH) means the radial distance from the base of the bead core to the outer diameter of the tire at its equatorial plane.

“Section width” (SW) means the maximum linear distance parallel to the axis of the tire and between the exterior of its sidewalls when and after it has been inflated at normal inflation pressure for 24 hours, but unloaded, excluding elevations of the sidewalls due to labeling, decoration or protective bands.

“Turn-up height” (TH) means the radial distance from the base of the bead core to the upper end of the turn-up.

Directions are also stated in this application with reference to the axis of rotation of the tire. The terms “upward” and “upwardly” refer to a general direction towards the tread of the tire, whereas “downward” and “downwardly” refer to the general direction towards the axis of rotation of the tire. Thus, when relative directional terms such as “upper” and “lower” are used in connection with an element, the “upper” element is spaced closer to the tread than the “lower” element. Additionally, when relative directional terms such as “above” or “below” are used in connection with an element, an element that is “above” another element is closer to the tread than the other element. The terms “axially inward” and “axially inwardly” refer to a general direction towards the equatorial plane of the tire, whereas “axially outward” and “axially outwardly” refer to a general direction away from the equatorial plane of the tire and towards the sidewall of the tire.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or multiple components.

### Tread Rubber Compositions.

The present disclosure describes a tire construction including a circumferential tread portion, and a sub-tread compound layer. The natural or synthetic rubbery polymer used for the circumferential tread portion, and for the sub-tread compound layer, both of which can generally be referred to as tread rubber, can be any polymer suitable for use in a tread rubber composition. Examples of rubbery polymers that may be used in the compositions described herein include, but are not limited to, natural rubber, synthetic polyisoprene rubber, styrene-butadiene rubber (SBR), styrene-isoprene rubber, styrene-isoprene-butadiene rubber, butadiene-isoprene-styrene terpolymer, butadiene-isoprene rubber, polybutadiene, butyl rubber, neoprene, acrylonitrile-butadiene rubber (NBR), silicone rubber, the fluoroelastomers, ethylene acrylic rubber, ethylene-propylene rubber, ethylene-propylene terpolymer (EPDM), ethylene vinyl acetate copolymer, epichlorohydrin rubber, chlorinated polyethylene-propylene rubbers, chlorosulfonated polyethylene rubber, hydrogenated nitrile rubber, and terafluoroethylene-propylene rubber. A mixture of rubbery polymers may be used. In one embodiment, the tread rubber composition may comprise a mixture of natural rubber and styrene-butadiene rubber.

The tread rubber composition preferably also contains a filler. The filler may be selected from the group consisting of carbon black, silica, and mixtures thereof. The total amount of filler may be from about 1 to about 200 phr, alternatively from about 5 to about 100 phr, from about 10 phr to about 30 phr, from about 30 to about 80 phr, or from about 40 to about 70 phr.

Carbon black, when present, may be used in an amount of about 1 to about 200 phr, in an amount of about 5 to about 100 phr, or alternatively in an amount of about 30 to about 80 phr. Suitable carbon blacks include commonly available, commercially-produced carbon blacks, but those having a surface area of at least 20 m²/g, or preferably, at least 35 m²/g up to 200 m²/g or higher are preferred. Among useful carbon blacks are furnace blacks, channel blacks, and lamp blacks. A mixture of two or more carbon blacks can be used. Exemplary carbon blacks include, but are not limited to, N-110, N-220, N-339, N-330, N-352, N-550, N-660, as designated by ASTM D-1765-82a.

Examples of reinforcing silica fillers which can be used include wet silica (hydrated silicic acid), dry silica (anhydrous silicic acid), calcium silicate, and the like. Among these, precipitated amorphous wet-process, hydrated silicas are preferred. Silica can be employed in an amount of about 1 to about 100 phr, in an amount of about 5 to about 80 phr, or alternatively in an amount of about 30 to about 80 phr. The useful upper range is limited by the high viscosity imparted by fillers of this type. Some of the commercially available silicas which can be used include, but are not limited to, HiSil® 190, HiSil® 210, HiSil® 215, HiSil® 233, HiSil® 243, and the like, produced by PPG Industries (Pittsburgh, Pa.). A number of useful commercial grades of different silicas are also available from DeGussa Corporation (e.g., VN2, VN3), Rhone Poulenc (e.g., Zeosil® 1165 MP0), and J. M. Huber Corporation.

The surface of the carbon black and/or silica may optionally be treated or modified to improve the affinity to particular types of polymers. Such surface treatments and modifications are well known to those skilled in the art.

If silica is used as a filler, it may be desirable to use a coupling agent to couple the silica to the polymer. Numerous coupling agents are known, including but not limited to organosulfide polysulfides and organoalkoxymercaptosilanes. Any organosilane polysulfide may be used. Suitable organosilane polysulfides include, but are not limited to, 3,3′-bis(trimethoxysilylpropyl)disulfide, 3,3′-bis(triethoxysilylpropyl)disulfide, 3,3′-bis(triethoxysilylpropyl)tetrasulfide, 3,3′-bis(triethoxysilylpropyl)octasulfide, 3,3′-bis(trimethoxysilylpropyl)tetrasulfide, 2,2′-bis(triethoxysilylethyl)tetrasulfide, 3,3′-bis(trimethoxysilylpropyl)trisulfide, 3,3′-bis(triethoxysilylpropyl)trisulfide, 3,3′-bis(tributoxysilylpropyl)disulfide, 3,3′-bis(trimethoxysilylpropyl)hexasulfide, 3,3′-bis(trimethoxysilylpropyl)octasulfide, 3,3′-bis(trioctoxysilylpropyl)tetrasulfide, 3,3′-bis(trihexoxysilylpropyl)disulfide, 3,3′-bis(tri-2″-ethylhexoxysilylpropyl)trisulfide, 3,3′-bis(triisooctoxysilylpropyl)tetrasulfide, 3,3′-bis(tri-t-butoxysilylpropyl)disulfide, 2,2′-bis(methoxydiethoxysilylethyl)tetrasulfide, 2,2′-bis(tripropoxysilylethyl)pentasulfide, 3,3′-bis(tricycloneoxysilylpropyl)tetrasulfide, 3,3′-bis(tricyclopentoxysilylpropyl)trisulfide, 2,2′-bis(tri-2″-methylcyclohexoxysilylethyl)tetrasulfide, bis(trimethoxysilylmethyl)tetrasulfide, 3-methoxyethoxypropoxysilyl 3′-diethoxybutoxy-silylpropyl tetrasulfide, 2,2′-bis(dimethylmethoxysilylethyl)disulfide, 2,2′-bis(dimethylsecbutoxysilylethyl)trisulfide, 3,3′-bis(methylbutylethoxysilylpropyl)tetrasulfide, 3,3′-bis(di t-butylmethoxysilylpropyl)tetrasulfide, 2,2′-bis(phenylmethylmethoxysilylethyl)trisulfide, 3,3′-bis(diphenyl isopropoxysilylpropyl)tetrasulfide, 3,3′-bis(diphenylcyclohexoxysilylpropyl)disulfide, 3,3′-bis(dimethylethylmercaptosilylpropyl)tetrasulfide, 2,2′-bis(methyldimethoxysilylethyl)trisulfide, 2,2′-bis(methyl ethoxypropoxysilylethyl)tetrasulfide, 3,3′-bis(diethylmethoxysilylpropyl)tetrasulfide, 3,3′-bis(ethyldisecbutoxysilylpropyl)disulfide, 3,3′-bis(propyldiethoxysilylpropyl)disulfide, 3,3′-bis(butyldimethoxysilylpropyl)trisulfide, 3,3′-bis(phenyldimethoxysilylpropyl)tetrasulfide, 3′-trimethoxysilylpropyl tetrasulfide, 4,4′-bis(trimethoxysilylbutyl)tetrasulfide, 6,6′-bis(triethoxysilylhexyl)tetrasulfide, 12,12′-bis(triisopropoxysilyl dodecyl)disulfide, 18,18′-bis(trimethoxysilyloctadecyl)tetrasulfide, 18,18′-bis(tripropoxysilyloctadecenyl)tetrasulfide, 4,4′-bis(trimethoxysilyl-buten-2-yl)tetrasulfide, 4,4′-bis(trimethoxysilylcyclohexylene)tetrasulfide, 5,5′-bis(dimethoxymethylsilylpentyl)trisulfide, 3,3′-bis(trimethoxysilyl-2-methylpropyl)tetrasulfide and 3,3′-bis(dimethoxyphenylsilyl-2-methylpropyl)disulfide.

Suitable organoalkoxymercaptosilanes include, but are not limited to, triethoxy mercaptopropyl silane, trimethoxy mercaptopropyl silane, methyl dimethoxy mercaptopropyl silane, methyl diethoxy mercaptopropyl silane, dimethyl methoxy mercaptopropyl silane, triethoxy mercaptoethyl silane, tripropoxy mercaptopropyl silane, ethoxy dimethoxy mercaptopropylsilane, ethoxy diisopropoxy mercaptopropylsilane, ethoxy didodecyloxy mercaptopropylsilane and ethoxy dihexadecyloxy mercaptopropylsilane. Such organoalkoxymercaptosilanes may be capped with a blocking group, i.e., the mercapto hydrogen atom is replaced with another group. A representative example of a capped organoalkoxymercaptosilane coupling agent is a liquid 3-octanoylthio-1-propyltriethoxysilane, commercially available as NXT™ Silane from Momentive Performance Materials Inc.

Mixtures of various organosilane polysulfide compounds and organoalkoxymercaptosilanes can be used.

The amount of coupling agent in the rubber composition is the amount needed to produce acceptable results, which is easily determined by one skilled in the art. The amount of coupling agent is typically based on the weight of the silica in the composition, and may be from about 0.1% to about 20% by weight of silica, from about 1% to about 15% by weight of silica, or alternatively from about 1% to about 10% by weight of silica.

Additional fillers may also be utilized, including but not limited to, mineral fillers, such as clay, talc, aluminum hydrate, aluminum hydroxide and mica. The foregoing additional fillers are optional and can be utilized in varying amounts from about 0.5 phr to about 40 phr.

The tread rubber composition may comprise zinc oxide in an amount of 0.1 to 10 phr, from 1 to 7 phr, or from 2 to 5 phr. Other ingredients that may be added to the tread rubber composition include, but are not limited to, oils, waxes, scorch inhibiting agents, tackifying resins, reinforcing resins, fatty acids such as stearic acid, and peptizers. These ingredients are known in the art, and may be added in appropriate amounts based on the desired physical and mechanical properties of the rubber composition.

Vulcanizing agents and vulcanization accelerators may also be added to the tread rubber composition. Suitable vulcanizing agents and vulcanization accelerators are known in the art, and may be added in appropriate amounts based on the desired physical, mechanical, and cure rate properties of the rubber composition. Examples of vulcanizing agents include sulfur and sulfur donating compounds. The amount of the vulcanizing agent used in the rubber composition may, in certain embodiments, be from about 0.1 to about 10 phr, or from about 1 to about 5 parts by weight per 100 phr.

When utilized, the particular vulcanization accelerator is not particularly limited. Numerous accelerators are known in the art and include, but are not limited to, diphenyl guanidine (DPG), tetramethylthiuram disulfide (TMTD), 4,4′-dithiodimorpholine (DTDM), tetrabutylthiuram disulfide (TBTD), benzothiazyl disulfide (MBTS), 2-(morpholinothio)benzothiazole (MBS), N-tert-butyl-2-benzothiazole sulfonamide (TBBS), N-cyclohexyl-2-benzothiazole sulfonamide (CBS), and mixtures thereof. The amount of vulcanization accelerator(s) used in the rubber composition may be from about 0.1 to about 10 phr or from about 1 to about 5 phr.

The rubber composition may be formed by mixing the ingredients together by methods known in the art, such as, for example, by kneading the ingredients together in a Banbury mixer. For example, the tread rubber composition may be mixed in at least two mixing stages. The first stage may be a mixing stage where no vulcanizing agents or vulcanization accelerators are added, commonly referred to by those skilled in the art as a non-productive mixing stage. In certain embodiments, more than one non-productive mixing stage may be used. The final stage may be a mixing stage where the vulcanizing agents and vulcanization accelerators are added, commonly referred to by those skilled in the art as a productive mixing stage. The non-productive mixing stage(s) may be conducted at a temperature of about 130° C. to about 200° C. The productive mixing stage may be conducted at a temperature below the vulcanization temperature in order to avoid unwanted pre-cure of the rubber composition. Therefore, the temperature of the productive mixing stage should not exceed about 120° C. and is typically about 40° C. to about 120° C., or about 60° C. to about 110° C. and, especially, about 75° C. to about 100° C.

### DETAILED DESCRIPTION

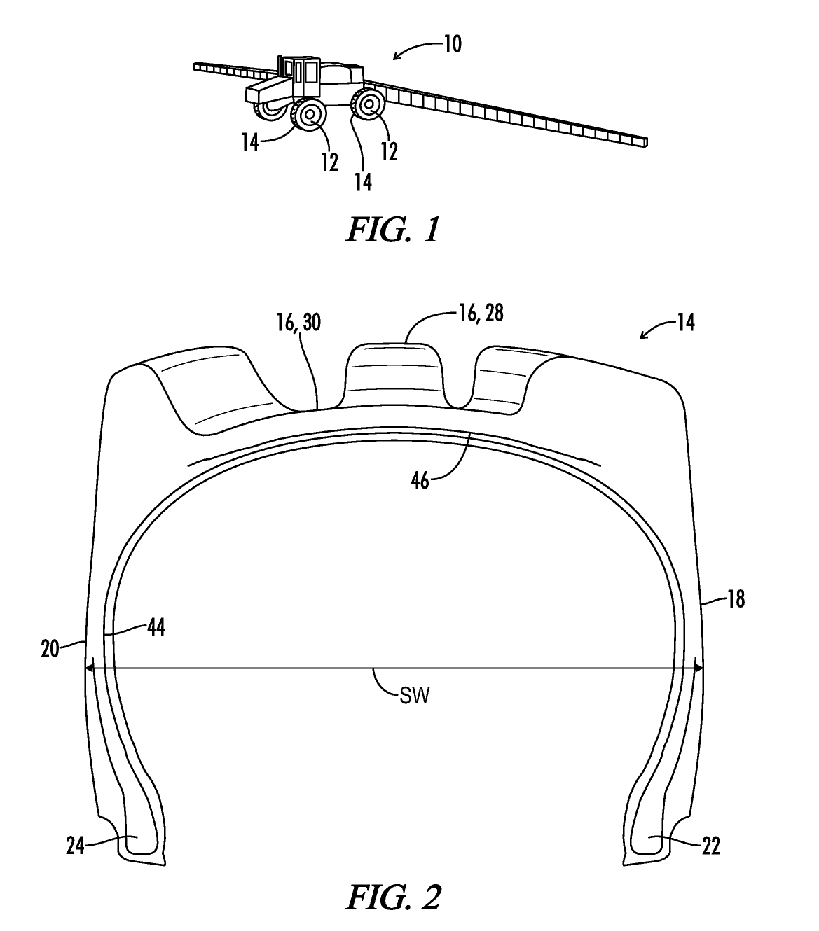

In FIG. 1 an agricultural machine 10 includes a plurality of wheels 12 each of which carries a pneumatic tire 14. The agricultural machine illustrated in FIG. 1 is a self-propelled sprayer. The tires thus described herein are suitable for use on self-propelled agricultural equipment including sprayers, tractors and combines, and other similar applications.

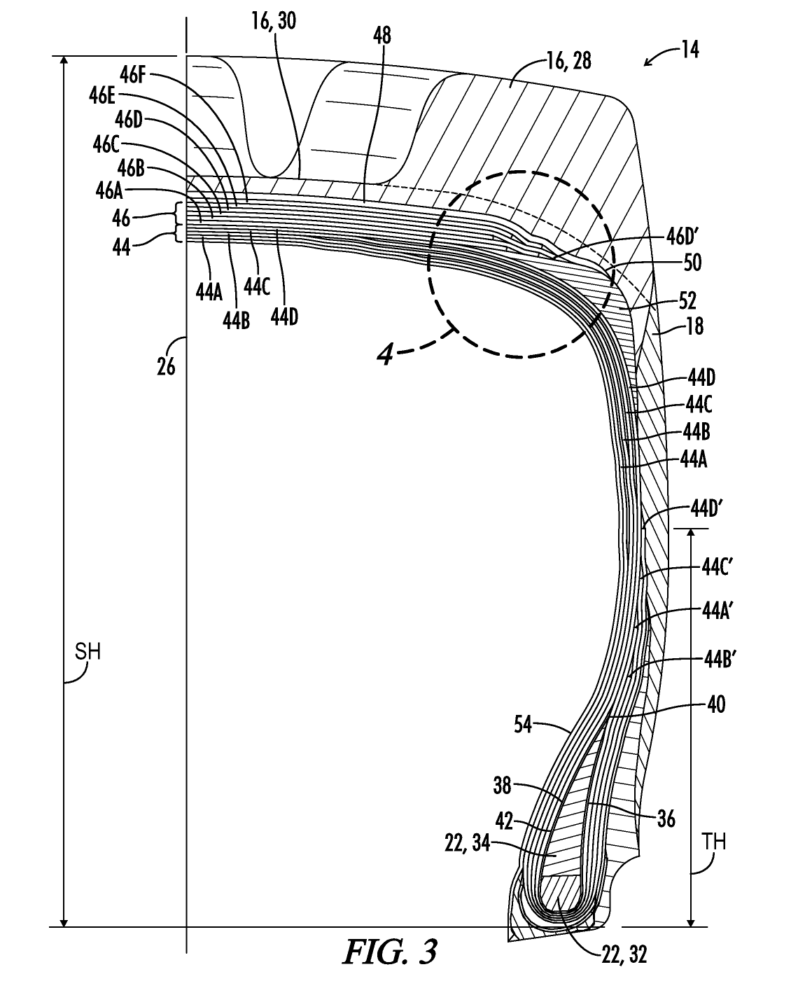

In FIG. 2 a cross-sectional view is shown of one embodiment of one of the tires 14. In FIG. 2 the various plies and belts are shown schematically only and their locations are shown by single lines. The details of those features for one embodiment are shown in the enlarged view of FIG. 3.

The tire 14 includes a circumferential tread or tread portion 16, first and second sidewalls or sidewall portions 18 and 20, and first and second beads or bead portions 22 and 24. The tread portion 16 includes a plurality of lugs 28 extending upward from a tread floor 30. As seen in FIG. 5, the tread includes first and second rows of lugs extending from first and second shoulders of the tread portion to or near the equatorial plane 26. The lugs extend at an angle 31 to the rotational axis of the tire. In the example shown the lugs 28 are slightly curved and angle 31 as measured from the centerline of the root of the lug to the centerline of the free end of the lug is about 37°. More generally, the angle 31 may be in a range of from 0° to 65°. The tread portion has a ratio of contact area of the lugs to total tread area of no greater than about 40%.

The agricultural tires utilizing the present design are also relatively large tires which may have outside diameters in a range of from about 40 to about 92 inches. The design is especially useful on the very large tires having outside diameters of greater than about 55 inches.

It will be understood that agricultural tires of the type shown have large deep lugs which in combination with the large open spaces in the tread pattern between lugs results in relatively large load concentrations directly below the lugs as contrasted to automotive tires, truck and bus tires, off the road tires, or construction equipment tires. Such agricultural tire tread types are specified in the industry as R-1, R-1W and R-2 tread codes as defined by the Tire and Rim Association.

Referring now to FIG. 3 an enlarged half sectional view of one embodiment of the tire 14 is shown wherein the drawing is split about the equatorial plane 26 of the tire. It will be understood that with regard to the internal features of the tire the half of the tire cross-section not shown is substantially a mirror image about the equatorial plane 26. The tread pattern may vary on either side of the equatorial plane.

The tire has a section width, SW, shown in FIG. 2, a section height, SH, shown in FIG. 3, and a turn-up height, TH, shown in FIG. 3.

As seen in FIG. 3, each of the bead portions such as bead portion 22 includes a bead core 32 and a bead filler 34. The bead core 32 comprises a bundle of bead wires. The bead filler 34 has upper walls 36 and 38 that converge to an apex or upper end 40 at a radially outer portion thereof. The bead portion 22 may be wrapped with a thin fabric layer sometimes referred to as a flipper 42.

A carcass 44 includes a plurality of carcass plies, sometimes also referred to as body plies. In the embodiment illustrated, the carcass 44 includes four and only four carcass plies 44A, 44B, 44C and 44D. In general, the carcass 44 may include from two to six carcass plies. Each of the carcass plies extends circumferentially about the tire. The carcass plies each include an axially inner portion and axially outer portions that extend around the bead portions and extend upwardly toward the tread portion and terminate at turn-up ends 44A′, 44B′, 44C′ and 44D′. The carcass plies 44A-44D may be nylon cord reinforced carcass plies, and are preferably radial plies.

A plurality of circumferentially extending belts 46 are disposed between the carcass 44 and the tread portion 16. In one embodiment the plurality of belts comprises from four to eight belts, and in the embodiment illustrated in FIG. 5 includes six and only six belts 46A, 46B, 46C, 46D, 46E and 46F. The belts 46A-46F may be polyester cord reinforced belts. The belts may be biased in alternating layers in a range of from about 69° to 77° to the rotational axis of the tire.

In another embodiment the tire may have two steel reinforced belts and from two to six fabric reinforced radial carcass plies. In still another embodiment the tire may have two steel reinforced belts and one steel reinforced radial carcass ply.

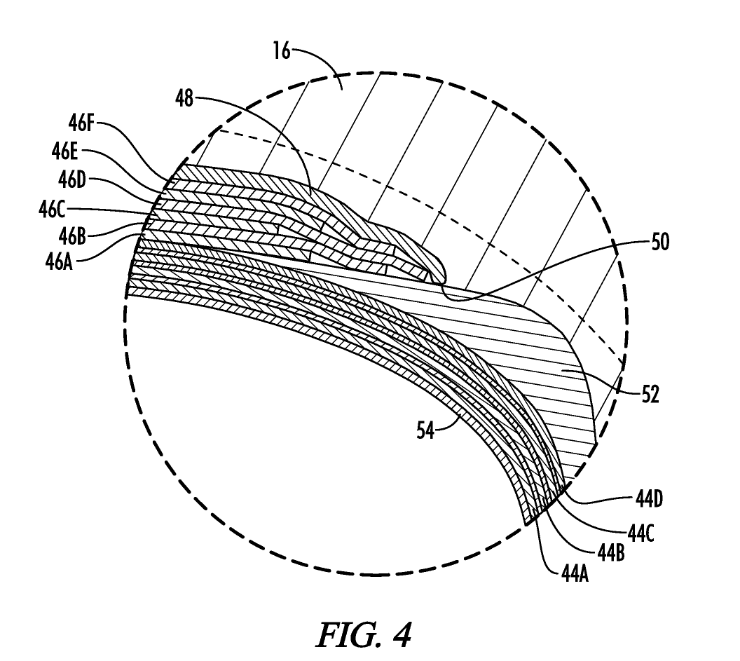

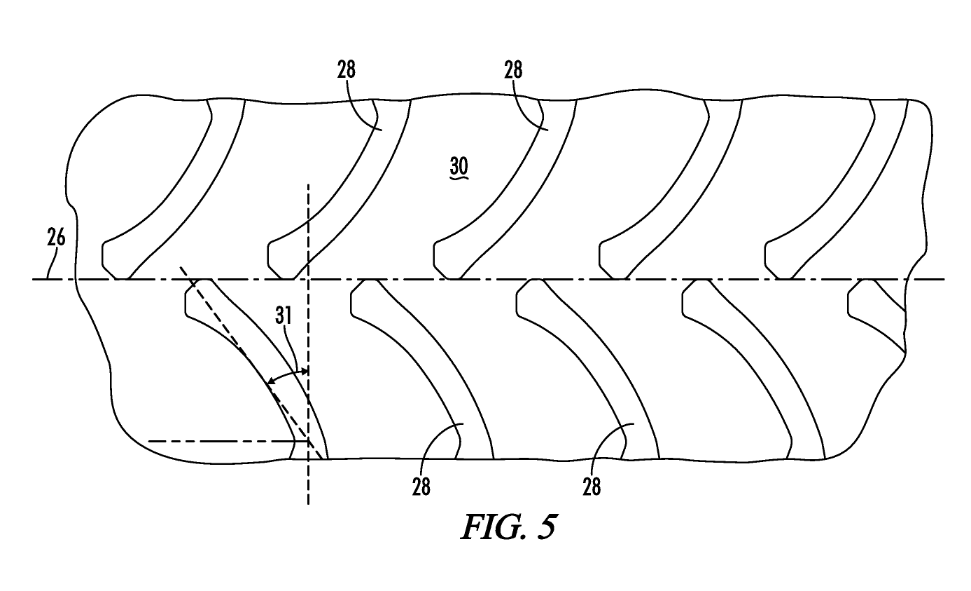

Each of the belts has axial end edges such as edge 46D′ denoted for the belt 46D. As is seen in FIGS. 3 and 4, the axial edges such as 46D′ of the various belts 46A-46F are staggered to create a tapered edge on the package of belts 46A-46F. A belt edge insert 52 extends under the edge of the belts 46, and also extends downward into the sidewall portion 18. The belt edge insert 52 serves to hold the axially outer portions of the belts in a substantially horizontal orientation so that they do not follow the downward curve of the carcass.

A sub-tread compound layer 48 is located between the circumferential tread portion 16 and the belts 46A-46F. In the embodiment of FIG. 3 it is seen that the sub-tread compound layer 48 extends to an axial edge 50 which extends well beyond the axial edges such as 46D′ of the belts 46A-46F and across most of the width of the belt edge insert 52. In the alternative embodiment shown in FIG. 4, the sub-tread compound layer 48 extends just past the belt edges and ends substantially adjacent the axial edges of the belts 46A-46F. The sub-tread compound layer 48 may be formed by calendaring a uniform thickness sheet of sub-tread compound material around the tire carcass on a rotating tire building machine.

The sub-tread compound layer 48 preferably has a radial thickness in the range of from about 0.1 inch to about 0.3 inch, more preferably in the range of from about 0.15 inch to about 0.25 inch, and most preferably approximately 0.2 inch. The thickness of the sub-tread compound layer 48 can also be described as being preferably at least about 0.1 inch, and more preferably at least about 0.15 inch.

The sub-tread compound layer 48 is made of a material having a lower hysteresis than does the circumferential tread portion 16. Thus the sub-tread compound layer may be referred to as a low hysteresis layer. The hysteresis of an elastomeric compound is a measure of the internal energy dissipation in the compound when subjected to deformation. With regard to tires, the hysteresis of the tire rubber compound relates to the amount of heat that will be generated internally in the compound when it is subjected to stresses such as those encountered in a rolling tire. A parameter commonly used to quantify the hysteresis of elastomeric compounds is the “tan delta” value of the compound. The tan delta value is the ratio of the viscous response to the elastomeric response of the compound, sometimes represented by the formula:

Tan delta=E″/E′, where

E″=loss modulus=viscous stress amplitude/strain amplitude, and

E′=elastic modulus=elastic stress amplitude/strain amplitude.

The tan delta factor varies with temperature, and thus is specified at a given temperature. The tan delta factor is also specified by the frequency and stress/strain conditions of the testing. For example, the tan delta of pure natural rubber at 60° C., measured at 10 Hz and 2% strain, is about 0.02. On the other hand, the tan delta at 60° C. for typical tread rubber compounds is generally in the range of 0.210 to 0.340.

The hysteresis of the sub-tread compound layer is dependent on both the rubber selected and the fillers added to the rubber. One factor which can contribute to a sub-tread compound layer having a lower hysteresis than the circumferential tread portion is to use a substantially higher natural rubber content in the sub-tread compound layer than in the circumferential tread portion 16. The hysteresis of the rubber compound can also be affected by the various fillers added to the rubber. The use of lower proportions of fillers also generally corresponds to lower hysteresis values for the rubber compound.

By selecting a sub-tread compound having a higher natural rubber content than that of the circumferential tread portion 16, and preferably having a rubber content of substantially 100% natural rubber, and/or by selecting a sub-tread compound having a relatively lower proportion of fillers, the sub-tread compound layer 48 will generate less heat internally than does the circumferential tread portion 16, thus exposing the belts 46 to less heat.

Preferably, the sub-tread compound layer should have a tan delta measured at 60° C. and at a 1.5% pre-strain with a 1% strain cycle at 52 Hz, in a range of from about 0.080 to about 0.150. The preferred range may also be described as being no greater than about 0.15. These measurement conditions refer to a measurement technique measured in tension, wherein a 1.5% pre-strain is applied to the sample. The measurement machine then applies a 1% strain cycle on top of the pre-strain, meaning that the strain on the sample cycles between 1.5% and 2.5% during the test. The frequency of the strain cycle is 52 Hz. It will be understood that when a material is specified herein by reference to a tan delta value measured at specific conditions, it does not require that the material has actually been measured at those conditions, but only requires that if the tan delta of the material were measured at those conditions it would have the specified value of tan delta.

For example, one suitable compound for the sub-tread compound layer 48 has a rubber content of 100% natural rubber, with a relatively low carbon black content of about 39 phr, and a relatively low silica content of about 5 phr, and a relatively low softener content of about 3 phr, resulting in a relatively low hysteresis identified by a tan delta measured at 60° C. and at a 1.5% pre-strain with a 1% strain cycle at 52 Hz, of about 0.106. Such a sub-tread compound material may be used with a tread material having a 30/70 synthetic/natural rubber blend, with a relatively high carbon black content of about 53 phr, and a relatively high softener content of about 15 phr, resulting in a relatively high hysteresis identified by a tan delta, measured at 60° C. and at a 1.5% pre-strain with a 1% strain cycle at 52 Hz, of about 0.230.

At speeds above about 30 mph, an agricultural tire of the type disclosed, and particularly one with large lugs 28 with a high void area therebetween such that the ratio of contact area to total tread area is no greater than about 40%, can generate significant internal temperatures due to the working of the tire at such high speeds. At speeds in excess of 30 mph there is the risk of the internally generated temperatures being sufficiently high so as to degrade the tensile strength of the reinforcing belts 46A-46F, if those belts are fabric belts, and in general the high temperatures may be detrimental to the long term durability of the rubber portions of the tire.

By selecting a sub-tread compound layer 48 having a lower hysteresis than does the circumferential tread portion 16, less heat will be internally generated in the sub-tread compound layer 48 adjacent the belts 46.

Preferably the sub-tread compound layer is formed of a material such that and having dimensions such that the tire can operate at rated load at a speed of 40 mph, while maintaining an operating temperature adjacent the belts of no greater than would be maintained by the same tire construction without the sub-tread compound layer at a speed of 30 mph. One test which may be used to confirm this result is as follows. Two tires having the inventive construction including the low hysteresis sub-tread compound layer are placed on the drive axle of a tractor. The axle weight of the tractor is equal to the rated load of the test tires. The tractor is driven around a closed loop track at 40 mph for two hours. At the end of two hours the tractor is stopped and the temperature above the belts is measured at various locations. The test is repeated three times to confirm the steady state temperature above the belts. A similar test is conducted with two standard tires of identical construction except that they do not include the sub-tread compound layer, and the standard tires are driven around the closed loop track at 30 mph for two hours. The operating temperatures measured in the inventive tires tested at 40 mph should not exceed the operating temperatures measured in the standard tires tested at 30 mph.

### Additional Description

Exemplary constructions for a pneumatic agricultural tire have been described. The following clauses are offered as further description of the disclosed invention.
(1) A pneumatic agricultural tire, comprising:
   a circumferential tread portion including first and second rows of tread lugs extending from first and second shoulders of the tread portion toward an equatorial plane of the tire, the lugs extending at an angle of from 0° to 65° to a rotational axis of the tire, the tread portion having a ratio of contact area to total tread area of no greater than about 40%;
   a pair of bead portions;
   a pair of sidewall portions extending from the bead portions to the tread portion;
   a carcass including at least one carcass ply extending circumferentially about the tire, the carcass ply including an axially inner portion and axially outer turn-up portions that extend around the bead portions and extend upwardly towards the tread portion and terminate at turn-up ends;
   a plurality of circumferentially extending belts disposed between the carcass and the circumferential tread portion; and
a low hysteresis sub-tread compound layer between the circumferential tread portion and the belts, the sub-tread compound layer having a lower hysteresis than the circumferential tread portion so that the sub-tread compound layer generates less heat internally than does the circumferential tread portion, the sub-tread compound layer having a thickness of at least 0.1 inch.
(2) The tire of clause 1, wherein the sub-tread compound layer has a substantially uniform thickness.
(3) The tire of any preceding clause, wherein the sub-tread compound layer comprises a uniform thickness calendared sheet of sub-tread compound.
(4) The tire of any preceding clause, wherein the sub-tread compound layer has a thickness in a range of from about 0.10 inch to about 0.30 inch.
(5) The tire of any preceding clause, wherein the sub-tread compound layer has a thickness in a range of from about 0.15 inch to about 0.25 inch.
(6) The tire of any preceding clause, wherein the sub-tread compound layer has a tan delta, measured at 60° C. and at a 1.5% pre-strain with a 1% strain cycle at 52 Hz, of no greater than 0.15.
(7) The tire of any preceding clause, wherein the sub-tread compound layer has a tan delta, measured at 60° C. and at a 1.5% pre-strain with a 1% strain cycle at 52 Hz, in a range of from about 0.080 to about 0.150.
(8) The tire of any preceding clause, wherein the sub-tread compound layer extends axially beyond axial edges of the belts.
(9) The tire of any preceding clause, wherein the sub-tread compound has a higher natural rubber content than does the circumferential tread portion.
(10) The tire of any preceding clause, wherein the sub-tread compound layer further comprises a rubber content of substantially 100% natural rubber.
(11) The tire of any preceding clause, wherein:
   the at least one carcass ply comprises from 2 to 6 radial carcass plies having nylon reinforcing cords; and
   the plurality of belts comprise from 4 to 8 belts having polyester reinforcing cords.
(12) The tire of any preceding clause, wherein the plurality of belts are steel reinforced belts.
(13) The tire of any preceding clause, wherein the tread portion has a tread type selected from the group consisting of R-1, R-1W and R-2 tread codes as defined by the Tire and Rim Association.
(14) The tire of any preceding clause, wherein the tire has an outside diameter of at least about 55 inches.
(15) The tire of any preceding clause, wherein the sub-tread compound layer is formed of a material such that and has dimensions such that the tire can operate at rated load at a speed of 40 mph, while maintaining an operating temperature adjacent the belts of no greater than would be maintained by the same tire construction without the sub-tread compound layer at a speed of 30 mph.

Thus it is seen that the apparatus of the present invention readily achieves the ends and advantages mentioned as well as those inherent therein. While certain preferred embodiments of the invention have been illustrated and described for purposes of the present disclosure, numerous changes in the arrangement and construction of parts may be made by those skilled in the art which changes are encompassed within the scope and spirit of the present invention as defined by the appended claims.

What is claimed is:

1. A pneumatic agricultural tire, comprising:
a circumferential tread portion including first and second rows of tread lugs extending from first and second shoulders of the tread portion toward an equatorial plane of the tire, the lugs extending at an angle of from 0° to 65° to a rotational axis of the tire, the tread portion having a ratio of contact area to total tread area of no greater than about 40%;
a pair of bead portions;
a pair of sidewall portions extending from the bead portions to the tread portion;
a carcass including at least one carcass ply extending circumferentially about the tire, the carcass ply including an axially inner portion and axially outer turn-up portions that extend around the bead portions and extend upwardly towards the tread portion and terminate at turn-up ends;
a plurality of circumferentially extending belts disposed between the carcass and the circumferential tread portion; and
a low hysteresis sub-tread compound layer between the circumferential tread portion and the belts, the sub-tread compound layer having a lower hysteresis than the circumferential tread portion so that the sub-tread compound layer generates less heat internally than does the circumferential tread portion, the sub-tread compound layer having a thickness of at least 0.1 inch.

2. The tire of claim 1, wherein:
the sub-tread compound layer has a substantially uniform thickness.

3. The tire of claim 1, wherein:
the sub-tread compound layer comprises a uniform thickness calendared sheet of sub-tread compound.

4. The tire of claim 1, wherein:
the sub-tread compound layer has a thickness in a range of from about 0.10 inch to about 0.30 inch.

5. The tire of claim 1, wherein:
the sub-tread compound layer has a thickness in a range of from about 0.15 inch to about 0.25 inch.

6. The tire of claim 1, wherein:
the sub-tread compound layer has a tan delta, measured at 60° C. and at a 1.5% pre-strain with a 1% strain cycle at 52 Hz, of no greater than 0.15.

7. The tire of claim 1, wherein:
the sub-tread compound layer has a tan delta, measured at 60° C. and at a 1.5% pre-strain with a 1% strain cycle at 52 Hz, in a range of from about 0.080 to about 0.150.

8. The tire of claim 1, wherein:
the sub-tread compound layer extends axially beyond axial edges of the belts.

9. The tire of claim 1, wherein:
the sub-tread compound has a higher natural rubber content than does the circumferential tread portion.

10. The tire of claim 1, wherein:
the sub-tread compound layer further comprises a rubber content of substantially 100% natural rubber.

11. The tire of claim 1, wherein:
the at least one carcass ply comprises from 2 to 6 radial carcass plies having nylon reinforcing cords; and
the plurality of belts comprise from 4 to 8 belts having polyester reinforcing cords.

12. The tire of claim 1, wherein:
the plurality of belts are steel reinforced belts.

13. The tire of claim 1, wherein:
the tread portion has a tread type selected from the group consisting of R-1, R-1W and R-2 tread codes as defined by the Tire and Rim Association.

14. The tire of claim 13, wherein:
the tire has an outside diameter of at least about 55 inches.

15. The tire of claim 1, wherein:
the tire has an outside diameter of at least about 55 inches.

16. The tire of claim 1, wherein:
the sub-tread compound layer is formed of a material such that and has dimensions such that the tire can operate at rated load at a speed of 40 mph, while maintaining an operating temperature adjacent the belts of no greater than would be maintained by the same tire construction without the sub-tread compound layer at a speed of 30 mph.

17. A pneumatic agricultural tire, comprising:
a tread portion, including first and second rows of tread lugs extending from first and second shoulders of the tread portion toward an equatorial plane of the tire, the lugs extending at an angle of from 0° to 65° to a rotational axis of the tire, the tread portion having a ratio of contact area to total tread area of no greater than 40%, and the tread portion having an outside diameter of at least about 55 inches;
a pair of opposing bead portions;
a carcass including from at least one radial carcass ply, each carcass ply having an axially inner portion and two turn-up portions, one turn-up portion extending from each end of the axially inner portion and having a terminal end, the axially inner portion extending between the opposing bead portions and the turn-up portions being located axially outward of the bead portions;
a plurality of belts, the belts being disposed between the carcass and the tread portion; and
a low hysteresis sub-tread compound layer between the circumferential tread portion and the belts, the sub-tread compound layer having a lower hysteresis than does the circumferential tread portion, the sub-tread compound layer being formed of a uniform thickness calendared sheet having a thickness in a range of from 0.1 to 0.3 inch.

18. The tire of claim 17, wherein:
the sub-tread compound layer has a thickness in a range of from about 0.15 inch to about 0.25 inch.

19. The tire of claim 17, wherein:
the sub-tread compound layer has a tan delta, measured at 60° C. and at a 1.5% pre-strain with a 1% strain cycle at 52 Hz, of no greater than 0.15.

20. The tire of claim 17, wherein:
the sub-tread compound layer has a tan delta, measured at 60° C. and at a 1.5% pre-strain with a 1% strain cycle at 52 Hz, in a range of from about 0.080 to about 0.150.

21. The tire of claim 17, wherein:
the sub-tread compound layer extends axially beyond axial edges of the belts.

22. The tire of claim 17, wherein:
the sub-tread compound has a higher natural rubber content than does the circumferential tread portion

23. The tire of claim 22, wherein:
the sub-tread compound layer further comprises a rubber content of substantially 100% natural rubber.

24. The tire of claim 17, wherein:
the tread portion has a tread type selected from the group consisting of R-1, R-1W and R-2 tread codes as defined by the Tire and Rim Association.

25. The tire of claim 17, wherein:
the at least one carcass ply comprises from 2 to 6 radial carcass plies having nylon reinforcing cords; and
the plurality of belts comprise from 4 to 8 belts having polyester reinforcing cords.

26. The tire of claim 17, wherein:
the plurality of belts are steel reinforced belts.

27. The tire of claim 17, wherein:
the sub-tread compound layer is formed of a material such that and has dimensions such that the tire can operate at rated load at a speed of 40 mph, while maintaining an operating temperature adjacent the belts of no greater than would be maintained by the same tire construction without the sub-tread compound layer at a speed of 30 mph.
